(19) United States
(12) Patent Application Publication
(10) Pub. No.: US 2005/0258341 A1
(43) Pub. Date: Nov. 24, 2005

(54) Light quantity detection circuit and display panel using the same

(75) Inventors: Ryuji Nishikawa, Gifu (JP); Takashi Ogawa, Gifu (JP)

Correspondence Address: Barry E. Bretschneider;Morrison & Foerster LLP, Suite 300, 1650 Tysons Boulevard, McLean, VA, 22102, US

(73) Assignee: Sanyo Electric Co., Ltd., Moriguchi-city (JP)

(21) Appl. No.: 11/133,464

(22) Filed: May 20, 2005

(30) Foreign Application Priority Data
May 21, 2004 (JP) 2004-152414
Jul. 12, 2004 (JP) 2004-205257

(51) Int. Cl. H01J 40/14

(52) U.S. Cl. 250/214.1

(57) ABSTRACT

Since a photosensor using a diode is incapable of perform refresh because of the structure, and the leak characteristics are unstable, the diode is not suitable for the photosensor. On the other hand, in a photosensor using a thin film transistor, since light quantity is very small, there has been a problem that feedback is difficult. A detection circuit converting an output current into a voltage is added to a photosensor using a thin film transistor. Thus, it is possible to convert a very small current into a voltage in a desired range enabling feedback. In addition, by varying resistors, capacitors, and the number of TFTs connected in the photosensor included in the circuit, it is made possible to change the sensitivity of the photosensor.

### BACKGROUND OF THE INVENTION

1. Field of the Invention

The present invention relates to a light quantity detection circuit of a photosensor and a display panel using the same, and more particularly to a light quantity detection circuit of a photosensor using a thin film transistor and a display panel using the same.

2. Description of the Related Art

With regard to modern display devices, flat panel displays prevail in response to market demand for size reduction, weight reduction, and thinner shape. In many such display devices, photosensors are incorporated, the photosenser, for example, detecting the external light and controlling the brightness of the display screen.

FIG. 11 shows a display device, in which a photosensor 306 is integrated with a liquid crystal display (LCD) 305, and which controls the backlight brightness of the LCD screen in response to environmental light received. As the photosensor, a photoelectric conversion element of a CdS cell, for example, is used (see Japanese Patent Application Publication No. H06-11713, for example).

In addition, technologies of forming a photodiode by providing a semiconductor layer on the substrate of the LCD or the organic electro luminescence display (see Japanese Patent Application Publication No. 2002-176162, for example), and of utilizing a thin film transistor as a photosensor (see Japanese Patent Application Publication No. 2003-37261, for example), are also known.

The displays as shown in FIG. 11 are manufactured in such a manner that a display unit and a photosensor are fabricated as separate modules through separate manufacturing processes by use of separate plants. Thus, there have naturally been limits to reduction in the number of parts in the equipment and to reduction in manufacturing cost of each module.

For this reason, technologies as are shown in JP2002-176162 cited above, in which technologies a display unit and a photosensor can be fabricated on the same substrate, are being developed. When a diode is used as a photosensor, leak current at reverse bias of the diode is detected as light quantity. In such a case, there are demands for achieving improvement in the photosensor characteristics and for life extension of the photosensor, by forcibly refreshing the photosensor at predetermined intervals.

However, in the case of the diode, since the gate electrode and the source (or the drain) are connected to each other, the gate electrode and the source are always at the same potential. That is, it is impossible to apply different voltages to the gate electrode and the source, respectively, and therefore to perform refresh. Moreover, in the case of the pn junction diode, there has been a problem that, since the leak characteristics during the time when light is not incident are unstable, the diode is not suitable for the photosensor.

In addition, a photosensor has been known which uses a thin film transistor and detects, as light quantity, the leakage current due to the light applied onto the thin film transistor while the transistor is turned off. However, the light quantity in this case is very small, and there has been a problem that feedback is difficult.

### SUMMARY OF THE INVENTION

The present invention provides a light quantity detection circuit that includes a photosensor comprising a thin film transistor comprising a gate electrode provided on a substrate, a semiconductor layer provided on the substrate, an insulating film interposed between the gate electrode and the semiconductor layer, the photosensor comprising light incident thereon into an output converting an electric signal, and the semiconductor layer comprising a channel, a source disposed at one end of the channel and a drain disposed at another end of the channel; a first resistor connected with the photosensor in parallel; a switching transistor comprising a gate receiving the output of the photosensor and a first and second terminals between which a current runs in response to the output of the photosensor, the first terminal of the switching transistor being connected with a first power terminal and the second terminal of the switching transistor being connected with a second power terminal; a second resistor connecting the first terminal of the switching transistor and the first power terminal; and an output terminal connected with a wiring connecting the second resistor and the first terminal of the photosensor.

The present invention also provides a light quantity detection circuit that includes a photosensor comprising a thin film transistor comprising a semiconductor layer disposed on a substrate, an insulating film disposed on the semiconductor layer and a gate electrode disposed on the insulating film, a gate electrode provided on a substrate, a semiconductor layer provided on the substrate, an insulating film interposed between the gate electrode and the semiconductor layer, the photosensor comprising light incident thereon into an output converting an electric signal, and the semiconductor layer comprising a channel, a source disposed at one end of the channel and a drain disposed at another end of the channel; a first capacitor comprising a first terminal receiving the output of the photosensor and a second terminal applied with a reference voltage; a first switching transistor allowing a current flow between a first and second terminals thereof, the first terminal of the first switching transistor being connected with the first terminal of the first capacitor; a second capacitor comprising a first terminal connected with the second terminal of the first switching transistor and a second terminal applied with the reference voltage; a second switching transistor comprising a first terminal connected with the first terminal of the second capacitor and a second terminal applied with the reference voltage; and a timing device supplying timing signals to the first and second switching transistors so that electric charges are stored in the first capacitor in response to the output of the photosensor, the electric charges stored in the first capacitor are transferred to the second capacitor by turning on the first switching transistor, and an output voltage is outputted from the first terminal of the second capacitor while the second switching transistor is turned off.

The invention further provides a light quantity detection circuit that includes a photosensor comprising a thin film transistor comprising a gate electrode provided on a substrate, a semiconductor layer provided on the substrate, an insulating film interposed between the gate electrode and the semiconductor layer, the photosensor comprising light incident thereon into an output converting an electric signal, and the semiconductor layer comprising a channel, a source disposed at one end of the channel and a drain disposed at another end of the channel; a first switching transistor allowing a current flow between a first and second terminals thereof, the first terminal of the first switching transistor receiving the output of the photosensor; a first capacitor comprising a first terminal connected with the second terminal of the first switching transistor and a second terminal applied with a reference voltage; a second switching transistor allowing a current flow between a first and second terminals thereof, the first terminal of the second switching transistor being connected with the first terminal of the first capacitor and the second terminal of the second switching transistor being connected with a power terminal; a third switching transistor allowing a current flow between a first and second terminals thereof, the first terminal of the third switching transistor being connected with the first terminal of the first capacitor; a second capacitor comprising a first terminal connected with the second terminal of the third switching transistor and a second terminal applied with the reference voltage; a fourth switching transistor allowing a current flow between a first and second terminals thereof, the first terminal of the fourth switching transistor being connected with the power terminal, the second terminal of the fourth switching transistor being applied with the reference voltage, and a gate of the fourth switching transistor being connected with the first terminal of the second capacitor; a resistor connecting the power terminal and the first terminal of the fourth switching transistor; an output terminal connected with a wiring connecting the resistor and the first terminal of the fourth switching transistor; and a timing device supplying timing signals to the first, second and third switching transistors so that electric charges are supplied from the power terminal to the first capacitor by turning on the second switching transistor, at least part of the electric charges supplied to the first capacitor is discharged through the photosensor by turning on the first switching transistor, and the electric charges remaining in the first capacitor are transferred to the second capacitor by turning on the third switching transistor.

The present invention further provides a display panel that includes a display unit formed on a substrate, the display unit comprising; a plurality of drain lines and a plurality of gate lines that are arranged in a matrix configuration, a plurality of display pixels, each of the display pixels being connected with one of the drain lines and one of the gate lines; and a light quantity detection circuit comprising a photosensor converting light incident thereon into an electric signal; and an external control circuit supplying control signal and a power for driving the display pixels and supplying the control signal, the power or the control signal and power to the light quantity detection circuit for an operation thereof

### BRIEF DESCRIPTION OF THE DRAWINGS

FIG. 1 is a circuit schematic diagram showing a light quantity detection circuit of a first embodiment of the present invention.

FIG. 2A is a cross-sectional view showing the structure of a photosensor of the first embodiment of the present invention.

FIGS. 2B and 2C are characteristics diagrams showing Id-Vg curves of photosensors of the first embodiment of the present invention.

FIG. 3 is a characteristics diagram showing a result of performing a simulation of the first embodiment of the present invention.

FIG. 4A is an exterior view for explaining the light quantity detection circuit and a display device of the first embodiment of the present invention.

FIG. 4B is a cross-sectional view of the first embodiment of the present invention.

FIG. 5A is a circuit schematic diagram showing a light quantity detection circuit of a second embodiment of the present invention.

FIG. 5B is a timing chart of the second embodiment of the present invention.

FIG. 6 is a detection flow diagram of the light quantity detection circuit of the second embodiment of the present invention.

FIG. 7 is a circuit schematic diagram showing the light quantity detection circuit of the second embodiment of the present invention.

FIG. 8A is a circuit schematic diagram showing a light quantity detection circuit of a third embodiment of the present invention.

FIG. 8B is a timing chart of the third embodiment of the present invention.

FIG. 9 is a circuit schematic diagram showing the light quantity detection circuit of the third embodiment of the present invention.

FIG. 10A is a schematic diagram for explaining a display panel of the embodiments of the present invention.

FIG. 10B is a flow chart for explaining the display panel of the embodiments of the present invention.

FIG. 11 is a schematic diagram showing a conventional photosensor.

### DESCRIPTION OF THE EMBODIMENTS

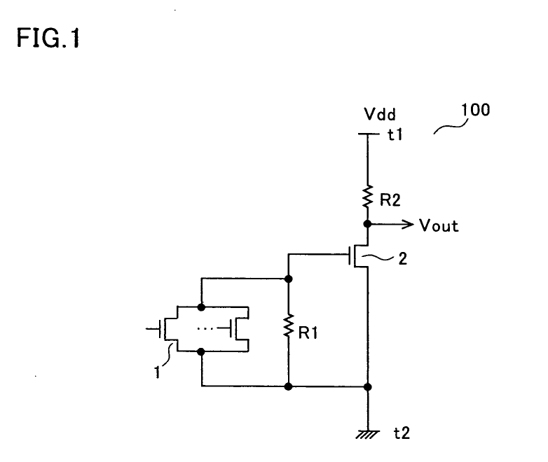

Embodiments of the present invention will be described in detail with reference to FIGS. 1 to 10B. First, a first embodiment is shown in FIGS. 1 to 4B.

FIG. 1 is a schematic diagram showing a light quantity detection circuit of the first embodiment.

As shown in FIG. 1, the light quantity detection circuit 100 of the first embodiment includes a photosensor 1, a first resistor R1, a second resistor R2, a switching transistor 2, a first power terminal t1, and a second power terminal t2.

The first resistor R1 is connected to the photosensor 1 in parallel, and has a very high resistance value of 10³ Ω to 10^{8 Ω.}

With regard to the switching transistor 2, the output terminal of the photosensor 1 is connected to the control terminal, one output terminal is connected to the first power terminal t1 via the second resistor R2, and the other output terminal is connected to the second power terminal t2. For example, the switching transistor 2 is a thin-film transistor (hereinafter referred to as “TFT”) of n-channel type, for example, and the structure thereof is similar to the below-described photosensor 1.

The second resistor R2 has a very high resistance value of 10³ Ω to 10⁸ Ω as the first resistor R1 has. The first power terminal t1 is at the VDD potential, and the second power terminal t2 is at the GND potential. In the first embodiment, by setting the voltages of the first and second terminals t1 and t2 having a desired range of potential difference, and connecting the second resistor R2 therebetween, it is made possible to obtain an output voltage Vout at a divided voltage between the voltages of the first and second power terminals t1 and t2.

That is, the voltages of the first and second power terminals t1 and t2 may be set in a range in which the output voltage Vout capable of being easily used as a feedback is produced. For example, the voltage of the first power terminal t1 may be set at +8V, and the voltage of the second power terminal t2 may be set at −7V.

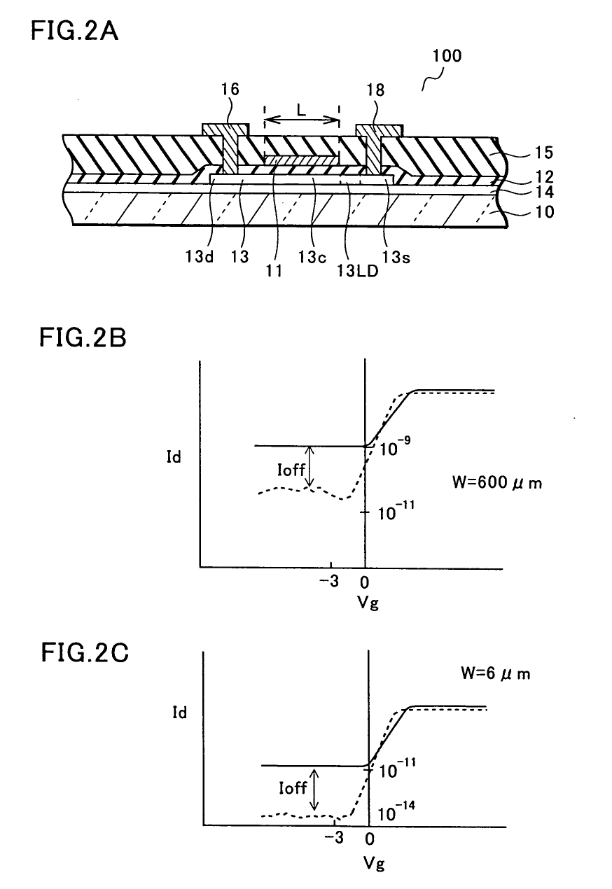

With reference to FIGS. 2A to 2C, a description will be given of the photosensor 1 of the first embodiment. FIG. 2A is a cross-sectional view showing the structure of the photosensor 1. FIGS. 2B and 2C are diagrams showing current-voltage characteristics of a TFT to be the photosensor 1.

The photosensor is composed of TFTs, each of which includes a gate electrode 11, an insulating film 12, and a semiconductor layer 13, as shown in FIG. 2A.

Specifically, an insulating film 14 (SiN, SiO₂ or the like), which serves as a buffer layer, is provided on an insulating substrate 10 made of silica glass, no-alkali glass or the like, and, on the top of the insulating film, the semiconductor layer 13 which is made of a polysilicon (hereinafter referred to as “p-Si”) film is deposited. The p-Si film may be formed by depositing an amorphous silicon film, and recrystallizing the film by laser annealing or the like.

On the semiconductor layer 13, the gate insulating film 12 made of SiN, SiO₂ or the like is deposited, and, on the top of the insulating film, the gate electrode 11 made of refractory metal, such as chrome (Cr), molybdenum (Mo) and the like, is formed.

In the semiconductor layer 13, an intrinsic, or substantially intrinsic, channel 13c which is located below the gate electrode 11 is provided. In addition, on both sides of the channel 13c, a source 13s and a drain 13d, which are n+impurity diffusion regions, are provided.

All over the gate insulating film 12 and the gate electrode 11, an SiO₂ film, an SiN film, and an SiO₂ film, for example, are sequentially deposited to form an interlayer insulating film 15. In the gate insulating film 12 and the interlayer insulating film 15, contact holes are made, corresponding to the drain 13d and the source 13s. The contact holes are filled with metal, such as aluminum (Al) and the like, to provide a drain electrode 16 and a source electrode 18, which are brought into contact with the drain 13d and the source 13s, respectively.

In the p-Si TFT of the above-described structure, incidence of light from the outside into the semiconductor layer 13 when the TFT is off causes electron-hole pairs to be generated in the junction region between the channel 13c and the source 13s or between the channel 13c and the drain 13d. The electron-hole pairs are separately attracted due to the electric field in the junction region to generate a photoelectromotive force, and a photocurrent is obtained. The photocurrent is outputted from the source electrode 18, for example.

That is, the increase of the photocurrent obtained when the TFT is off (hereinafter referred to as output current Ioff) is detected, and the TFT is thereby used as a photosensor.

Here, the semiconductor layer 13 may be provided with a low concentration impurity region. The low concentration impurity region is a region which is provided adjacent to the source 13s or the drain 13d on the channel 13c side, and which is lower in impurity concentration compared to the source 13s or the drain 13d. By providing this region, it is made possible to relax the electric field concentrated at the edge of the source 13s (or the drain 13d). However, if the impurity concentration is excessively lowered, the electric field will increase. Moreover, the width of the low concentration impurity region (the length from the edge of the source 13s in the direction toward the channel 13c) also influences the electric field strength. That is, there exist optimal values of the impurity concentration of the low concentration impurity region and the width thereof. The optimal value of the width is approximately 0.5 μm to 3 μm, for example.

In this embodiment, a low concentration impurity region 13LD is provided, for example, between the channel 13C and the source 13S (or between the channel 13C and the drain 13D) to form a so-called light doped drain (LDD) structure. With the LDD structure, it is possible to increase, in the direction of the gate length L, the junction region contributing to photocurrent generation, so that photocurrent generation occurs more readily. That is, it is advantageous that the low concentration impurity region 13LD is provided at least on the drain side in terms of the photocurrent. In addition, by adopting the LDD structure, the turn-off characteristics (the region of detecting light quantity) of gate voltage Vg-drain current Id characteristics is stabilized, and a stable device can be obtained.

Incidentally, FIGS. 2B and 2C show the gate voltage Vg-drain current Id characteristics of TFTs to be the photosensor. FIG. 2B is a diagram of the TFT with a gate width of 600 μm, and FIG. 2C is a diagram of the TFT with a gate width of 6 μm. In addition, both of the TFTs have a gate length L of 13 μm. These graphs show the cases where there is incident light (solid line) and where there is no incident light (broken line), in a condition where, for example, n-channel type TFTs are used, and the drain voltage Vd and the source voltage Vs are 10 V and GND, respectively.

According to FIGS. 2B and 2C, when the gate voltage Vg is equal to or lower than about −1V to 0V, the TFTs are turned off, and, when the gate voltage Vg exceeds the threshold value, the TFTs are turned on, and the drain current Id increases. When attention is focused on the vicinity of the gate voltage Vg=−3V at which the TFT is completely turned off, in the case of FIG. 2B, the drain current Id, which is approximately 1×10⁻¹¹ A when there is no incident light, increases up to approximately 1×10⁻⁹ A due to incidence of light. The drain current Id which increases due to the incident light is the output current Ioff.

On the other hand, as shown in FIG. 2C, when the gate width W is small, the photocurrent, which is approximately 1×10⁻¹⁴ A when there is no incident light, becomes 1×10⁻¹¹ A due to incidence of light.

As described above, by adopting a large gate width W, it is possible to obtain a larger output current Ioff compared to the case of a smaller gate width W if the light quantity is equal.

It is possible to detect the current as the output current Ioff in either case. However, with the current of the order of this level, it is difficult to provide feedback.

For this reason, this embodiment provides a circuit for reading a very small current of the above photosensor 1 as shown in FIG. 1, thereby making it possible to detect a sufficient quantity of light for feedback.

It should be noted that the photosensor 1 of the circuit shown in FIG. 1 is composed of one or more, and less than approximately 500 of TFTs described above (FIG. 2A). In a case where a plurality of TFTs are used, the gate electrodes 11 are made common, and the TFTs are connected to each other in parallel. In this embodiment, one hundred of TFTs are connected to each other in parallel as an example.

In addition, the TFTs (for example, the switching transistor 2) which are included in the light quantity detection circuit 100, except for the photosensor 1, may have a so-called top gate structure in which the gate electrode 11 is located in the upper layer of the semiconductor layer 13 as shown in FIG. 2A, or may have a bottom gate structure in which the gate electrode 11 is located in the lower layer of the semiconductor layer 13. If the TFTs other than the photosensor 1 have a top gate structure, it is advantageous to provide the TFTs with light shielding layers. It is conceivable that, for example, by disposing gate electrodes above and below the semiconductor layer, the gate electrode in the lower layer is used as a light shielding layer. In this case, the potential of the gate electrode, which serves as the light shielding layer, can be a floating one, the same potential as that of the gate electrode in the upper layer, or a different potential therefrom, for example, the potential of the gate electrode in the lower layer being selected as appropriate according to the circuit configuration.

Referring back to FIG. 1, a description will be given below of an operation of the light quantity detection circuit 100.

When the photosensor 1 is irradiated with light, a very small photocurrent, which is approximately 10⁻¹⁴ A to 10⁻⁹ A, for example, is outputted. This output current becomes approximately 1×10⁻¹⁰ A to 1×10⁻⁹ A due to the first resistor R1 with a high resistance value, and the voltage corresponding to the current is applied to the gate electrode of the switching transistor 2.

When the switching transistor 2 is turned on, a current flows from the first power terminal t1 to the second power terminal t2. Then, the output voltage Vout is detected at the connection point between one output terminal of the switching transistor 2 and the second resistor R2. Here, the output voltage Vout at the connection point can be detected as a divided voltage of the first power terminal t1 and the second power terminal t2.

The gate voltage of the switching transistor 2 increases or decreases in response to the output current Ioff of the photosensor 1, resulting in variations in the amount of the current which flows from the first power terminal t1 to the second power terminal t2. That is, when the output current Ioff of the photosensor 1 is small, the gate voltage is low, and the current flowing through the second resistor R2 is small. Thus, since the second resistor R2 has a very large resistance value as described above, the output voltage Vout becomes high.

On the other hand, when the output current Ioff of the photosensor 1 becomes large, since the gate voltage becomes high, the current flowing through the second resistor R2 becomes large, and the output voltage Vout becomes low.

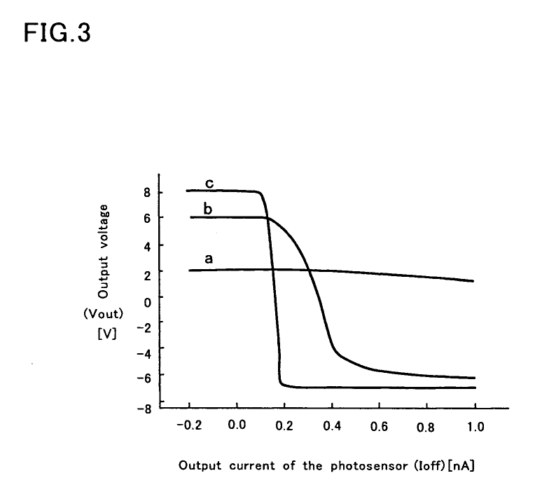

FIG. 3 shows a result of performing a simulation of this circuit.

The horizontal axis of the graph is the output current Ioff of the photosensor 1, and the vertical axis is the converted output voltage Vout. The voltage between the first and second power terminals was −7V to 8V, which was made variable in steps of 2V. Moreover, the resistance value R of the second resistor R2 was made variable. With regard to the second resistor R2, the solid lines a, b and c indicate the cases of 1×10⁴ Ω, 1×10⁶ Ω and 1×10⁸ Ω, respectively.

As described above, with this embodiment, although the output current Ioff from the photosensor 1 is very small, which is 0.1 nA to 1 nA, this output current Ioff is converted into voltage and amplified into the range of −7V to 8V, so that the light intensity can be detected.

For example, when the first power terminal t1 is 8V, and the resistance R of the second resistor R2 is 1×10⁶ Ω, the output current Ioff of 0 nA can be converted into 6V, and the output current Ioff of 1 nA can be converted into −6V.

In addition, as also apparent from the solid lines a to c, by varying the resistance value of the second resistor R2, it is possible to change the current-voltage characteristics of the output current Ioff of the photosensor 1 and the output voltage Vout. Specifically, when the value R is large, the current-voltage characteristics become steep, and, when the value R is small, the characteristics become gentle. That is, by means of the resistance value of the second resistor R2, it is possible to change the output current-output voltage characteristics of the photosensor 1. In other words, it is possible to change the sensitivity of the light quantity detection circuit 100.

Accordingly, when R=1×10⁸ Ω, for example, since the curve rises almost vertically, turning on and off can be carried out between 8V and −7V, that is, it is possible to use the light quantity detection circuit as a switch. When R=1×10⁶ Ω, since the potential variation is gentle, a voltage value corresponding to the output current Ioff can be determined. For example, the light quantity detection circuit is suitable in such a case where the circuit is used stepwise in response to the brightness (the light quantity), that is, where it is desired to output an analog data instead of a digital data of 0s and 1s.

Here, the photosensor 1 is used in such a way that dark current (leak current) is generated by irradiation with light at the time when the TFT of the photosensor 1 is off, as described above. Accordingly, it is advantageous that the photosensor is forcibly refreshed at predetermined timings.

In the photosensor 1 which is composed of the TFTs, by applying a predetermined voltage to the gate electrodes 11, it is possible to turn on the TFTs. That is, voltages with which a current flows in the direction opposite to the direction in which the photocurrent flows are applied to the gate electrodes 11, the drains 13d and/or the sources 13s at predetermined intervals. Thus, it is possible to refresh the photosensor 1, and to stabilize the characteristics of the TFTs as the photosensor 1.

However, if these are diodes instead of the TFTs, the gate electrode and the source (or the drain) are connected to each other, and thus are always at the same potential. That is, it is impossible to apply different voltages to the gate electrode and the source, respectively, and to perform refresh. Moreover, in the case of the pn junction diode, since the leak characteristics during the time when light is not incident are unstable, the diode is not suitable for the photosensor.

It should be noted that, in this embodiment, also the switching transistor 2 is a TFT similar to that of the photosensor 1 of FIG. 1. Moreover, it is preferable that the switching transistor 2 also has the LDD structure, because it is possible to relax the electric field concentrated at the edge of the source (or the drain).

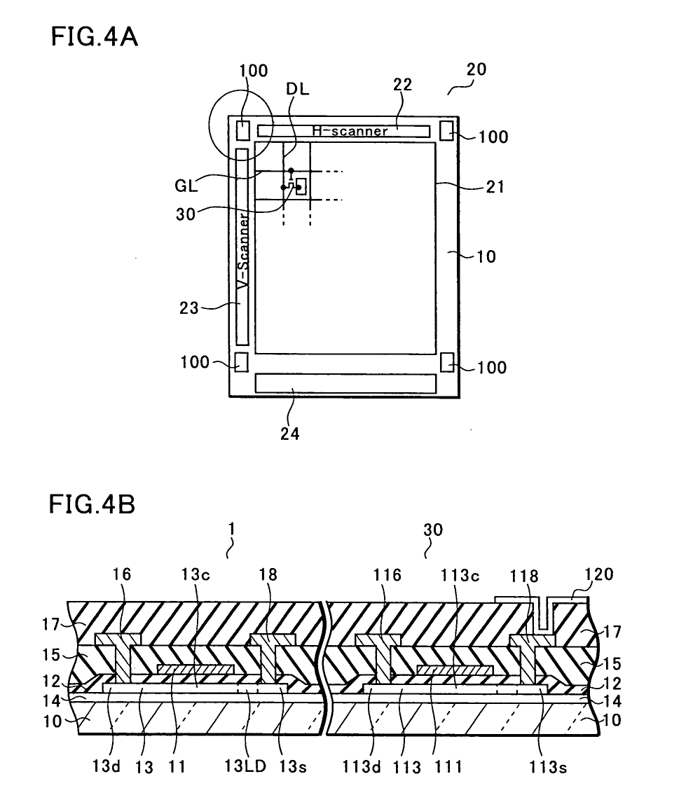

Here, with reference to FIGS. 4A and 4B, a description will be given of an example of a case where the light quantity detection circuit 100 of this embodiment is built onto the substrate of the LCD or the organic electro luminescence display, for example.

FIG. 4A is an example showing an exterior view of a display. FIG. 4B is a cross-sectional view for explaining a part of the light quantity detection circuit 100 and a display pixel 30.

As shown in FIG. 4A, the light quantity detection circuit 100 of this embodiment is provided on the substrate of an LCD or an organic electro luminescence display device. The display device 20 has a display area 21 in which a plurality of display pixels 30 are disposed in a matrix arrangement on the insulating substrate 10, such as a glass plate. The light quantity detection circuits 100 are disposed at the four corners outside of the display area 21, for example.

On the substrate, a plurality of drain lines DL, and a plurality of gate lines GL are disposed, and the display pixels 30 are disposed, each corresponding to each of the intersections of the drain lines DL and the gate lines GL. Specifically, each display pixel 30 is connected to the source of a drive TFT, and the drain and the gate of the TFT is connected to the drain line DL and the gate line GL.

In addition, at sides of the display area 21, a horizontal scanning circuit (hereinafter referred to as the H scanner) 22, which sequentially selects the drain line DL, is disposed at a side thereof in terms of the columns, and a vertical scanning circuit (hereinafter referred to as the V scanner) 23, which sends gate signals to the gate lines GL, is disposed at a side thereof in terms of the row.

Assume that a gate signal of a certain potential (“H” level) is being applied to a certain gate line GL by the V scanner 23, for example. The TFTs connected to the gate line GL to which the gate signal is applied are all brought into conduction (turned on). During this period, scanning signals are sequentially switched and applied to the drain lines DL at predetermined timings by the H scanner 22, and thus the display pixels 30 located at the intersections emit light. In this way, by sequentially scanning the gate lines GL and the drain lines DL, a desired image is displayed on the display area 21. Incidentally, lines not shown, which transmit various signals inputted to the gate lines GL and the drain lines DL are gathered to a side of the substrate 10, and are connected to an external connector 24.

The light detection circuit 100 is provided on the substrate 10, on which the display pixels 30 are disposed, so the light detection circuit 100 can sense substantially the same light quantity as the light incident on the display area 21. Moreover, light is directly incident onto the junction region between the source 13s and the channel 13c, or the drain 13d and the channel 13c of the photosensor 1. That is, the photosensor 1 directly receives the external light. Accordingly, it is made possible to sense the quantity of light which is incident onto the display area 21 and convert the light quantity into current by use of the photosensor 1, and to adjust the brightness of the display area 21, that is, for example, to control a controller. The controller allows the display area 21 to be bright outdoors or when the interior of a room is bright, or to exhibit a brightness corresponding to the environment when the environment is dark, in response to the amount of the output current Ioff. That is, the brightness is made higher when the environment is bright, and is made lower when the environment is dark. In this way, by automatically adjusting the brightness in response to the light quantity of the environment, it is possible to conserve electricity while the viewability is improved. Accordingly, by controlling the brightness by use of the light quantity detection circuit 100, especially in the display device 20 in which self-luminous elements, such as organic electro luminescence elements, are used, it is made possible to extend the life of light emitting elements.

As shown in FIG. 4B, the light quantity detection circuit 100 and the display pixels 30 are provided on the same substrate. Incidentally, in this figure, only the photosensor 1 of the light quantity detection circuit 100 is shown.

The display pixel 30 also has a TFT similar to that of the photosensor 1. Specifically, the insulating film (made of SiN, SiO₂ or the like) 14, which serves as a buffer layer, is provided on the insulating substrate 10 made of silica glass, no-alkali glass or the like, and, on the top of the insulating film, a semiconductor layer 113 which is made of a p-Si film is deposited. The p-Si film may be formed by depositing an amorphous silicon film, and recrystallizing the film by laser annealing or the like.

On the semiconductor layer 113, the gate insulating film 12 made of SiN, SiO₂ or the like is deposited, and, on the top of the gate insulating film, a gate electrode 111 made of refractory metal, such as chrome (Cr), molybdenum (Mo) and the like, is formed.

In the semiconductor layer 113, an intrinsic, or substantially intrinsic, channel 113c which is located below the gate electrode 111 is provided. In addition, on both sides of the channel 113c, a source 113s and a drain 113d, which are n⁺ impurity diffusion regions, are provided.

All over the gate insulating film 12 and the gate electrode 111, an SiO₂ film, an SiN film, and an SiO₂ film, for example, are sequentially deposited to form the interlayer insulating film 15. In the gate insulating film 12 and the interlayer insulating film 15, contact holes are made, corresponding to the drain 113d and source 113s. The contact holes are filled with metal, such as aluminum (Al) and the like, to provide a drain electrode 116 and a source electrode 118, which are brought into contact with the drain 113d and the source 113s, respectively.

Incidentally, the photosensor 1 is similar to that of FIG. 1, and therefore description thereof is omitted. However, on the interlayer insulating film 15 of the photosensor 1 and the display pixel 30, a planarizing insulating film 17 for planarizing the display pixel 30 is formed.

In addition, a transparent electrode 120, which is made of indium tin oxide (ITO) or the like and serves as a display electrode, is provided to the display pixel 30 on the planarizing insulating film 17. The transparent electrode 120 is connected to the source electrode 118 (or the drain electrode 116) through a contact hole made in the planarizing insulating film 17.

In such a case, the first and second resistors R1, R2 may be formed by use of transparent electrode material, such as ITO, or p-Si doped with an n-type impurity, for example.

Instead, the first and second resistors R1, R2 may be formed as TFTs similar to the photosensor 1 and the TFTs of the display pixel 30. In this case, the TFT can be used as a resistor by fixing the gate voltage so that the source/drain resistance of the TFT becomes high.

With the above configuration, by using a manufacturing process of the display device 20 which is formed by providing thin film transistors on a substrate, it is possible to fabricate the light quantity detection circuit 100 of this embodiment on the same substrate.

Incidentally, in the above case, among others, p-Si doped with impurities is deteriorated due to exposure to light, and the resistance value becomes small. For this reason, in such a case, it is advantageous to provide light shielding over the first and second resistors R1, R2. In the LCD or the organic electro luminescence display device 20, since a shielding plate (not shown) is employed on the display area 21 in which the display pixels 30 are disposed, it is possible to provide light shielding over the first and second resistors R1, R2 by patterning the shielding plate.

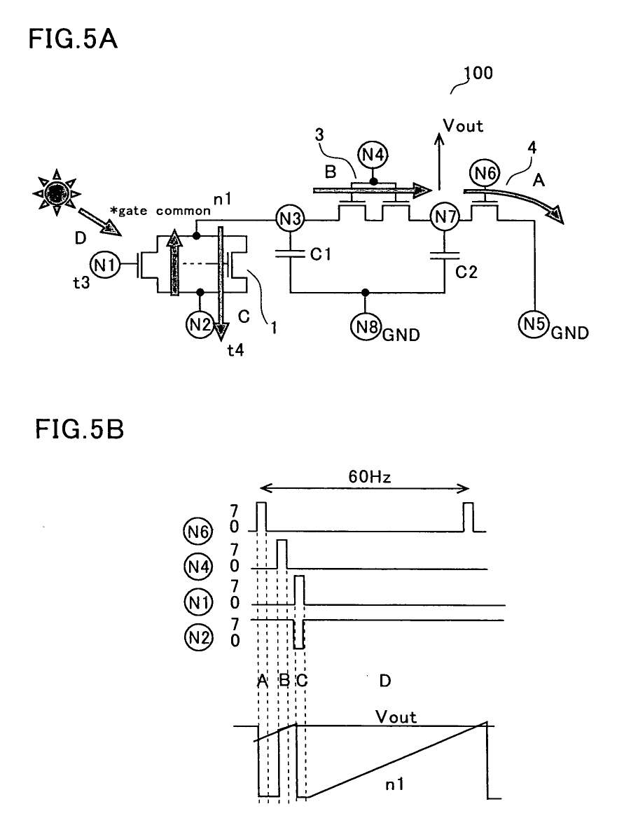

Next, a description will be given of a second embodiment of the present invention with reference to FIGS. 5A to 7. Incidentally, the same components as those of the first embodiment are indicated by the same reference numerals.

FIG. 5A is a circuit schematic diagram showing the second embodiment. FIG. 5B is a timing chart of the circuit.

A light quantity detection circuit 100 of this embodiment includes a photosensor 1, a first capacitor C1, a second capacitor C2, a first switching transistor 3, and a second switching transistor 4.

As shown in FIG. 5A, the photosensor 1 is formed by connecting a plurality of TFTs in parallel, the gate electrodes of which are made common. Since the detail of the TFT is similar to that of the first embodiment, description thereof is omitted. Also as in the case of the first embodiment, in order to refresh the photosensor 1, a node N1, to which the control terminal (the gate) of the photosensor 1 is connected, and a node N2, to which one output terminal (the drain or the source) of the photosensor 1 is connected, are connected to predetermined power terminals t3 and t4, respectively. Voltages with which a current flows in the direction opposite to the direction in which the photocurrent flows are applied to the gate electrodes, the drains and/or the sources of the photosensor 1 at predetermined intervals.

The first capacitor C1 has a capacitance value of 2 pf, for example, and one terminal thereof is connected to the output terminal of the photosensor 1. The second capacitor C2 has a capacitance value in the range of 1 fF to 1 nF (a capacitance value of 400 fF, for example), and is connected in parallel with the first capacitor C1.

The first switching transistor 3 is connected between nodes N3 and N7. That is, one terminal of the first and second capacitors C1 and C2 are connected to the output terminals of the first switching transistor 3. In addition, the other terminal of the first capacitor C1 is connected to the other terminal of the second capacitor C2, and is grounded at a node N8.

A control signal is applied to the control terminal of the first switching transistor 3 at a node N4. In addition, in this embodiment, a double-gate n-channel type TFT is used for the first switching transistor 3 because the leak current can be suppressed.

The output voltage Vout is detected at the connection point (the node N7) between the output terminal of the first switching transistor 3 and the second capacitor C2. One output terminal of the second switching transistor 4 is connected to the node N7, and the other output terminal of the transistor 4 is grounded at a node N5. The second switching transistor 4 preferably has a good turn-off characteristics independent of the types of n and p.

Incidentally, also in this embodiment, it is advantageous that the photosensor 1 and the switching transistors 3 and 4 have the so-called LDD structure.

Next, a description will be given of an operation of the above-described light quantity detection circuit. In FIGS. 5A and 5B, corresponding timings A to D are shown.

As shown in FIG. 5B, at the timing C, a pulse of an H level (7V, for example) is inputted to the node N1 of the photosensor 1, and a pulse of an L level (0V, for example) is inputted to the node N2, thereby refreshing the photosensor 1. As a result, the voltage of the node N3 falls as shown by n1.

The pulse falls, and the nodes N1 and N2 get back to the L level and the H level, respectively. Then, the first capacitor C1 is charged by the output current Ioff of the photosensor 1. Thereafter, during a predetermined period of time, the first capacitor C1 is charged by the output current Ioff, and the voltage of the node N3 varies (increases) as shown by n1. Since the first capacitor C1 is grounded at the node N8, the voltage n1 of the node N3 is the output voltage from the photosensor 1.

At the timing A, a pulse of the H level is inputted to a node N6, thereby turning on the second switching transistor 4 and resetting the output voltage Vout of the preceding sampling.

At the timing B, a pulse of the H level is inputted to the node N4, thereby turning on the first switching transistor 3. As a result, during a predetermined period of time, the electric charges stored in the first capacitor C1 move to the second capacitor C2. Since the other terminal of the second capacitor C2 is also grounded, by detecting the output voltage Vout which is outputted from the node N7, it is possible to detect the light quantity (light intensity) received by the photosensor 1.

That is, in this embodiment, the gradient of the voltage n1 of the node N3 varies in response to the light quantity received by the photosensor 1, and the output voltage Vout varies with the voltage n1. That is, it is possible to obtain the output voltage Vout which varies linearly in response to the light quantity.

In addition, by varying the capacitance values of the first and second capacitors C1 and C2, it is possible to adjust the sensitivity of detecting the light quantity. Here, the capacitance value of the first capacitor C1 is set larger than that of the second capacitor C2. In this way, the electric charges can be efficiently transferred.

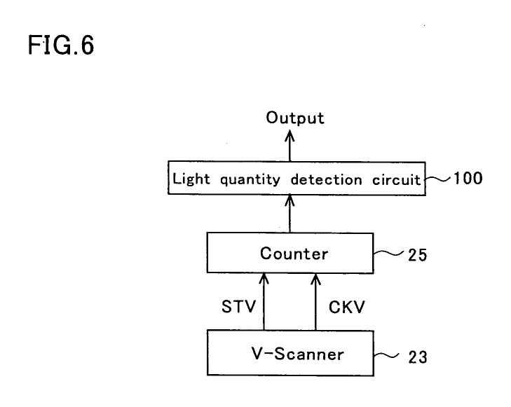

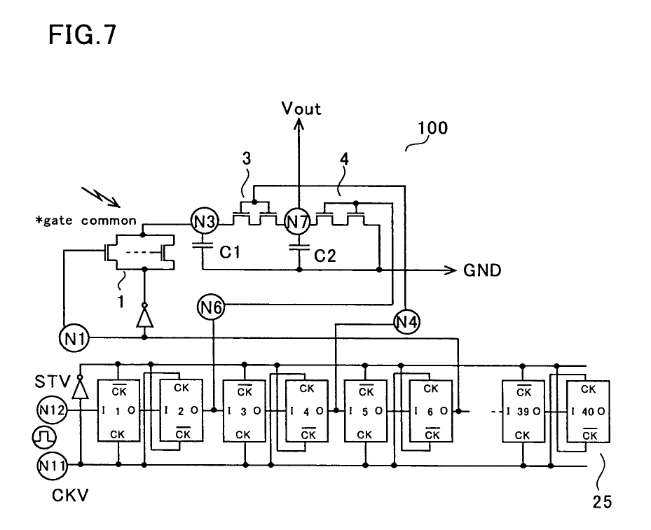

Next, with reference to FIGS. 6 and 7, a description will be given of an example of a case where the above-described light quantity detection circuit is fabricated onto the substrate of the LCD or the organic electro luminescence display device.

FIG. 6 is a diagram showing a detection flow of the photosensor. FIG. 7 is an example of a configuration diagram of a circuit which includes the light quantity detection circuit of the second embodiment and a counter for inputting pulses into the detection circuit. Incidentally, since the exterior view is similar to FIG. 4, this figure will be referred to.

The light quantity detection circuits 100 are disposed at the four corners outside of a display area 21, for example. At sides of the display area 21, an H scanner 22, which sequentially selects a drain line DL, is disposed at a side thereof in terms of the columns, and a V scanner 23, which sends gate signals to gate lines GL, is disposed at a side thereof in terms of the row.

The V scanner 23 sequentially selects a certain gate line GL out of the plurality of gate lines GL to apply a gate voltage thereto. The V scanner 23 selects the first gate line GL following a vertical start signal STV, and sequentially switches over to and selects the next gate line GL in response to a vertical clock CKV.

The H scanner 22 sequentially selects a certain drain line DL out of the plurality of drain lines DL to supply signals to display pixels 30. The H scanner 22 selects the first drain line DL following a horizontal start signal STH, and sequentially switches over to and selects the next drain line DL in response to a horizontal clock CKH.

The vertical clock CKV and the horizontal clock CHK are generated by boosting the low voltage clock with an amplitude of 3V, for example, by use of a potential transformation circuit, the clock being outputted by an external control circuit.

In this embodiment, as shown in FIG. 6, the vertical start signal STV and the horizontal clock CKV of the V scanner 23 are inputted to a counter 25, and by use of the pulses outputted from the counter 25, the timings A to D shown in FIG. 5 are generated.

FIG. 7 is an example of a circuit configuration in which the light quantity detection circuit 100 and the counter 25 are connected to each other. In this embodiment, the vertical clock CKV of the V scanner 23 is inputted to the node N11 of the counter 25, and the vertical start signal STV of the V scanner 23 is inputted to a node N12 of the counter 25.

The pulse which is applied to the gate electrodes of the photosensor 1 in order to perform refresh is the output (the node N1) of the sixth stage of the counter 25. In addition, the signal line and the output terminal of the photosensor are connected to each other via an inverter.

The pulses which are applied to the gate electrodes of the first switching transistor 3 and the second switching transistor 4, respectively, are the outputs (the nodes N4 and N6) of the fourth and second stages of the counter 25, respectively.

It should be noted that, when the clock of the V scanner 23 of the display device 20 is used in such a manner, the period of the timing A of FIG. 5B is the period within which one frame of the display area 21 is scanned. Although 60 Hz is mainly used, for example, 30 Hz, 120 Hz and so on may be used.

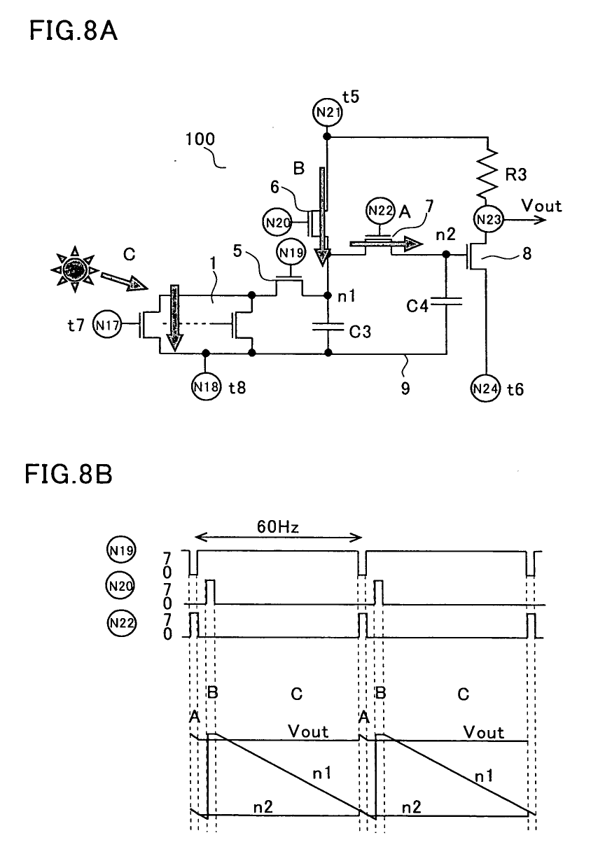

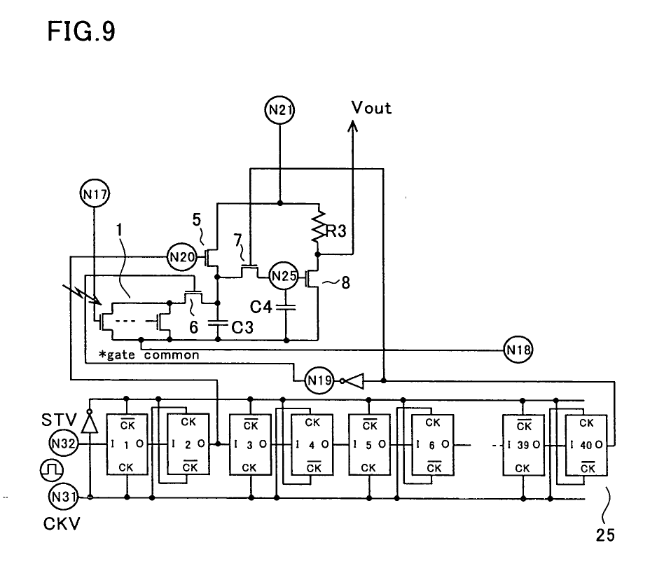

Next, with reference to FIGS. 8A to 9, a description will be given of a third embodiment of the present invention.

FIG. 8A is a circuit schematic diagram showing the third embodiment. FIG. 8B is a timing chart of the circuit. In FIGS. 8A and 8B, corresponding timings A to C are shown.

As shown in FIG. 8A, a light quantity detection circuit 100 includes a photosensor 1, a first capacitor C3, a second capacitor C4, a first switching transistor 5, a second switching transistor 6, a third switching transistor 7, connection 9, a fourth switching transistor 8, a resistor R3, a first power terminal t5, and a second power terminal t6.

The photosensor 1 is formed by connecting a plurality of TFTs in parallel, the gate electrodes of which are made common. Since the detail of the TFT is similar to that of the first embodiment, description thereof is omitted. Also as in the case of the first embodiment, in order to refresh the photosensor 1, nodes N17 and N18 are connected to predetermined power terminals t7 and t8, respectively, and voltages with which a current flows in the direction opposite to the direction in which the photocurrent flows are applied to the gate electrodes, the drains and/or the sources of the photosensor 1 at predetermined intervals.

The first capacitor C3 is connected in parallel with the photosensor 1, and has a capacitance value of approximately 2 pF, for example.

The output terminals of the first switching transistor 5 are connected in series to one output terminal of the photosensor 1 and one terminal of the first capacitor C3, respectively. With regard to the second switching transistor 6, one output terminal is connected to the first power terminal t5, and the other output terminal is connected to the connection point between the first switching transistor 5 and the first capacitor C3.

With regard to the third switching transistor 7, one output terminal is connected to one output terminal of the second switching transistor 6, and the other output terminal is connected to one terminal of the second capacitor C4. The other terminal of the second capacitor C4 is connected to the first capacitor C3 via the connection 9.

Moreover, one terminal of the second capacitor C4 is connected to the control terminal of the fourth switching transistor 8. With regard to the fourth switching transistor 8, one output terminal is connected to the second power terminal t6, and the other output terminal is connected to the first power terminal t5 via the resistor R3. The resistor R3 has a very high resistance value of approximately 2 MΩ, for example. The output voltage Vout is detected at a node N23.

Incidentally, the first to fourth switching transistors are n-channel type TFTs, for example. In addition, as described above, it is preferable that the photosensor 1 and the switching transistors have the LDD structure.

As shown in FIG. 8B, at the timing A, a pulse of an L level (0V, for example) is inputted to a node N19, and the first switching transistor 5 is turned off. Thereafter, when the voltage of the node N19 rises to an H level (7V, for example), the first switching transistor 5 is turned on, and the conduction is maintained until the next timing A.

At timing B, a pulse of the H level is inputted to a node N20. During the pulse duration, the second switching transistor 6 is turned on. As a result, electric charges are supplied from the first power terminal t5 to the first capacitor C3, so that the first capacitor C3 is charged to the voltage of a node N21. In the third embodiment, after reference electric charges are stored in the first capacitor C3, the light quantity is detected by use of their discharge. Accordingly, the state where the first capacitor C3 is charged to the voltage of the node N21 is the reset state of voltage n1.

When the pulse of the node N20 becomes the L level, the second switching transistor 6 is turned off. At this time, the first switching transistor 5 is held in conduction, the electric charges stored in the first capacitor C3 is discharged during the timing C.

The photosensor 1, as described above, uses a dark current generated in response to the quantity of light which is applied to the photosensor 1 when the TFTs constituting the photosensor 1 are turned off. That is, light quantity is detected by detecting the current which leaks from the TFTs constituting the photosensor due to the light. Accordingly, by holding the first switching transistor 5 in conduction, the electric charges corresponding to the quantity of light applied to the photosensor 1 are discharged from the first capacitor C3.

Following the end of the period of the timing C, a pulse of the L level is inputted to the node N19 at the timing A again, and, during the pulse duration, the first switching transistor 5 is turned off. At the same time, a pulse of the H level is inputted to the node N22, and the third switching transistor 7 is turned on.

Accordingly, during the pulse duration, electric charges move from the first capacitor C3 to the second capacitor C4, that is, the voltage n2 varies in response to the voltage n1. As shown in FIG. 8B, the voltage n1 decreases with time due to the discharge, and the remaining amount of electric charges, which results from the subtraction of the electric charges corresponding to the light quantity detected by the photosensor 1 from the reference electric charges by means of the conduction of the third switching transistor 7, gives the voltage n2.

That is, the voltage n2 varies in response to the light quantity sensed by the photosensor 1, and the voltage n2 is applied to the gate electrode of the fourth switching transistor 8.

Then, since the resistor R3 with a very high resistance value of approximately 2 MΩ is connected between the nodes N21 and N23, the voltage between the first and second power terminals t5 and t6 is divided, and the output voltage Vout is detected at the node N23. In this case, with regard to the fourth switching transistor 8, if the gate voltage n2 is low, the current which flows through the resistor R3 becomes small, and thus the output voltage Vout is outputted at a large value near the voltage of the first power terminal t5 (Vdd, for example). On the other hand, if the gate voltage n2 is high, the current which flows through the resistor R3 becomes large, and thus the value of the output voltage Vout becomes a small value near the voltage of the second power terminal t6 (GND, for example).

That is, with this embodiment, the voltage n2 varies in response to the light quantity (intensity) sensed by the photosensor 1, whereby the output voltage Vout can be varied. In addition, since the output voltage Vout can be transformed to a voltage between the first and second power terminals t5, t6, it is possible to convert a very small photocurrent into a voltage having a range adequate for the intended purpose and to output the voltage.

In addition, with regard to the light quantity detection circuit 100 of the third embodiment, it is possible to adjust the sensitivity of detecting the light quantity by varying the number of TFTs connected in the photosensor 1.

Moreover, with reference to an example of a configuration diagram of a circuit which includes the light quantity detection circuit and a counter 25 for inputting pulses into the detection circuit shown in FIG. 9, a description will be given of a case where the light quantity detection circuit is fabricated onto the substrate of the LCD or the organic electro luminescence display device.

An exterior view of the display device is similar to FIG. 4. Since a detection flow of the photosensor 1 is similar to FIG. 6, description thereof is omitted.

As shown in FIG. 9, in the case of the third embodiment, a vertical clock CKV and a vertical start signal STV of a V scanner 23 is inputted to nodes N31 and N32 of the counter 25, respectively.

The pulse which is applied to the gate electrode of the first switching transistor 5 is the output of the second stage of the counter 25 (node N20). The pulse which is applied to the gate electrode of the second switching transistor 6 is obtained by inverting the output of the 40th stage of the counter 25 by use of an inverter (node N19), for example. In addition, the pulse which is applied to the gate electrode of the third switching transistor 7 is the output of the 40th stage of the counter.

The resistor of the third embodiment may also be formed by use of transparent electrode material, such as ITO, or p-Si doped with an n-type impurity, or as a TFT, as in the case of the first embodiment. In the case of the TFT, this can be used as a resistor by fixing the gate voltage so that the source/drain resistance of the TFT becomes high.

With the above configuration, by using a manufacturing process of a display device 20 which is formed by providing thin film transistors on a substrate, it is possible to fabricate the light quantity detection circuit 100 of this embodiment on the same substrate.

Incidentally, in the case of forming the resistor by use of p-Si doped with impurities, it is advantageous to provide light shielding over the resistor by patterning the shielding plate of the LCD or the organic electro luminescence display device 20.

As a specific usage of the above-described light quantity detection circuit 100, for example, since the output voltage Vout is linear relative to the output of the photosensor 1 in the light quantity detection circuit 100 of the second embodiment, with at least one light quantity detection circuit 100, it is possible to control brightness in response to the light quantity and the like.

In the case of the light quantity detection circuit 100 of the first or the third embodiment, the sensitivity is changed by varying the number of TFTs connected in the photosensor 1 or due to the variation of the first and second resistors. That is, with one light quantity detection circuit 100, it is possible to detect the on or off state at the sensitivity (whether the sensitivity is reached or not). Accordingly, in these cases, a plurality of light quantity detection circuits 100 with different sensitivities may be disposed in the display, and the light quantity may be detected by detecting the photosensor 1 whose output is on.

It should be noted that, although the description has been given of the case of the TFT having the so-called top gate structure in this embodiment, the embodiment of the present invention can be similarly implemented with TFTs having a bottom gate structure in which the stacking order is inverted.

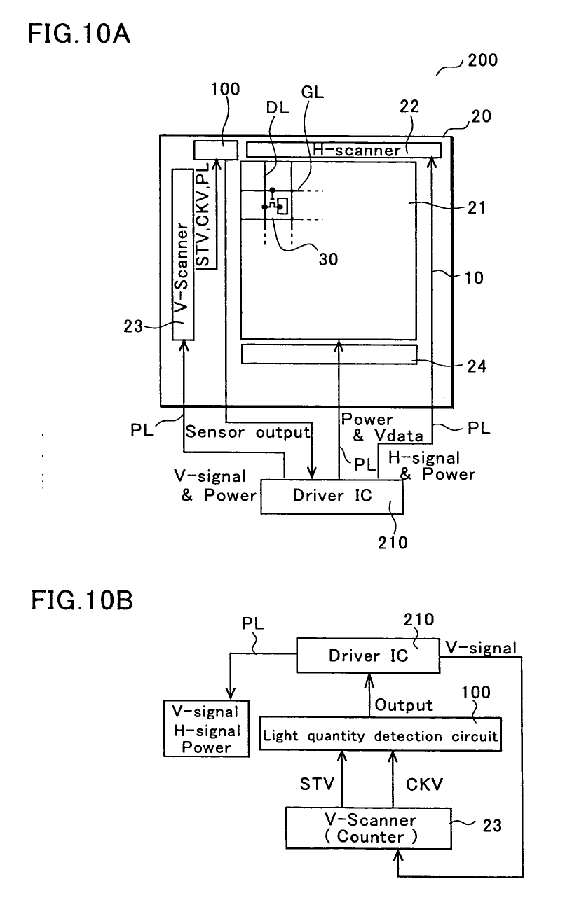

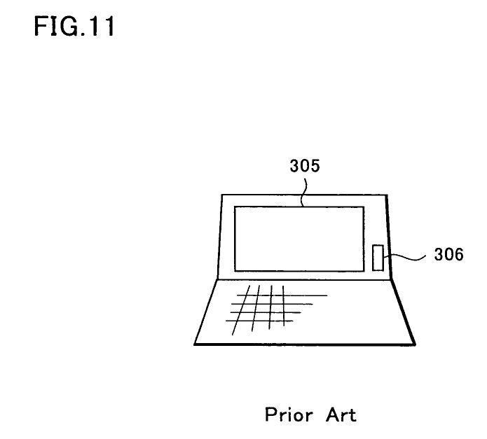

FIGS. 10A and 10B are diagrams for explaining an operation of a display panel 200 of this embodiment. FIG. 10A is a schematic diagram. FIG. 10B is a flow chart.

As described above, the display panel 200 of this embodiment includes the display unit 20, and an external control circuit 210 for driving the display unit 20. The display unit 20 is formed by disposing the display area 21, in which a plurality of the display pixels 30 are connected to the gate lines GL and the drain lines DL as described above, the V scanner 23, the H scanner 22, and the light quantity detection circuit 100 on the same substrate 10.

The external control circuit 210 is a so-called driver IC which supplies various signals and/or power for driving through power supply lines PL to the display unit 20.

The driver IC 210 drives the V scanner 23 and the H scanner 22, and sends control signals (V-signal, H-signal). The V scanner 23 and the H scanner 22 supply scanning signals to the gate lines GL and the drain lines DL, respectively, in response to the control signals.

In addition, the driver IC 210 supplies power to the display unit 20. Part of the power is supplied to organic electro luminescence elements of the display pixels 30, so that the organic electro luminescence elements emit light. Moreover, the driver IC 210 outputs a data signal Vdata to the display unit 20 to display an image.

The light quantity detection circuit 100 has the first and second power terminals. Incidentally, in the case of the light quantity detection circuit 100 of the second or the third embodiment, the timings of refresh and detection of the photosensor 1 are controlled by use of predetermined pulses as input signals.

In the display panel 200 of this embodiment, the first and second power terminals of the light quantity detection circuit 100 are connected to power supply lines PL of the driver IC 210. In addition, in the case of the light quantity detection circuit 100 requiring input signals, scanning signals of the V scanner 23 are inputted, for example.

Specifically, as shown in FIG. 10B, the vertical start signal STV and/or the vertical clock CKV outputted from the V scanner 23 (the counter 25), for example, are inputted to the light quantity detection circuit 100 in response to the control signals (V-signal) from the driver IC 210, allowing the light quantity detection circuit 100 to operate.

The light quantity detection circuit 100 detects the external light to convert into voltage as described above, and supplies the voltage to the driver IC 210. Thus, the driver IC 210 performs feedback to the display unit 20, which is to adjust the brightness of the organic electro luminescence elements, for example.

When the light quantity detection circuit 100 is driven by the power supply of the display panel 200 and the scanning signal (STVCKV) of the V scanner of the display panel 200, for example, as described above, the need for supplying operation signals for the light quantity detection circuit 100 from outside is eliminated, and it is made possible to reduce the number of terminals.

In addition, corresponding to the reduction in the voltage drop caused by the wiring resistance, the power consumption of the light quantity detection circuit 100 can be reduced.

With the embodiments of the present invention, first, the very small output current of the photosensor can be detected in such a way that the current is converted (and amplified) into the voltage. In addition, since the output voltage is the divided voltage between the voltages of the first and second power terminals, and the voltages of the first and second power terminals may be set in a desired range, feedback of the sensed light quantity becomes easy.

Second, since it is possible to change the current-voltage characteristics of the photosensor by varying the resistance value of the resistor included in the circuit, it is possible to adjust the sensitivity of the photosensor according to applications.

Third, by setting the resistance value of the resistor included in the circuit at a resistance value in the range of 10³ Ω to 10⁸ Ω, the output voltage can be set in a desired range suitable for feedback, which range is −7V to a little more than 8V for example.

Fourth, by charging the capacitor for a certain period of time by the output current of the photosensor and thereby converting the current into the output voltage, a circuit in which the linear relation between the output current and the output voltage is provided, can be realized.

Fifth, by varying the capacitance value of the capacitor charged by the output current of the photosensor, it is possible to change the sensitivity of detecting the light quantity of the photosensor.

Sixth, by connecting a plurality of photosensor elements in parallel, and converting the sensed light quantity into the output voltage by discharging the electric charges corresponding to the light quantity sensed from the reference electric charges, it is possible to amplify the very small output current into a voltage in a desired range.

Seventh, by varying the number of TFTs connected in the photosensor, it is possible to change the sensitivity of detecting the light quantity of the photosensor.

Eighth, since the photosensor is composed of the TFT(s), it is possible to refresh the photosensor by applying a predetermined voltage to the control terminal after a lapse of a predetermined period of time. In this way, it is possible to achieve life extension of the TFT and to obtain stable sensing characteristics.

Ninth, since the photosenser is directly irradiated with light, the external light can be substantially directly detected.

Tenth, by adopting the LDD structure for the TFT of the photosensor, it is possible to promote generation of photocurrent. Especially, the LDD structure on the output side of the photocurrent will be effective to promote generation of photocurrent. In addition, by adopting the LDD structure, the turn-off characteristics (the region of detecting light quantity) of gate voltage Vg-drain current Id characteristics is stabilized, and a stable device can be obtained.

Eleventh, by forming the resistor out of transparent electrode material, it is possible to integrally provide the light quantity detection circuit by using a manufacturing process of, for example, the LCD, the organic electro luminescence display or the like, using thin film transistors.

Twelfth, by forming the resistor as a thin film transistor, it is possible to produce a built-in light quantity detection circuit by using a manufacturing process of a display device using a thin film transistor.

Thirteenth, by using the power of the display device and the signals supplied to display an image data from the V scanner or the like to the display unit also for driving the light quantity detection circuit, the need for supplying operation signals for the light quantity detection circuit from outside is eliminated, and it is made possible to reduce the number of terminals.

In addition, corresponding to the reduction in the voltage drop caused by the wiring resistance, the power consumption of the photosensor (the light quantity detection circuit) can be reduced.

1. A light quantity detection circuit comprising:
a photosensor comprising a thin film transistor comprising a gate electrode disposed on a substrate, a semiconductor layer disposed on the substrate, an insulating film disposed between the gate electrode and the semiconductor layer, the photosensor converting light incident thereon into an output comprising an electric signal, and the semiconductor layer comprising a channel, a source disposed at one end of the channel and a drain disposed at another end of the channel;
a first resistor connected with the photosensor in parallel;
a switching transistor comprising a gate receiving the output of the photosensor and a first and second terminals between which a current runs in response to the output of the photosensor, the first terminal of the switching transistor being connected with a first power terminal and the second terminal of the switching transistor being connected with a second power terminal;
a second resistor connecting the first terminal of the switching transistor and the first power terminal; and
an output terminal connected with a wiring connecting the second resistor and the first terminal of the photosensor.

2. The light quantity detection circuit of claim 1, wherein the second resister is adjusted so as to provide a predetermined current-voltage characteristic of the photosensor.

3. The light quantity detection circuit of claim 1, wherein each of the first and second resistors has a resistance between 10³ Ω and 10^{8 Ω.}

4. The light quantity detection circuit of claim 1, wherein the gate electrode of the thin film transistor of the photosensor is configured to receive a predetermined voltage to refresh the photosensor after the output terminal outputs an output voltage.

5. The light quantity detection circuit of claim 1, wherein the thin film transistor is configured to receive light in a junction region of the semiconductor layer between the channel and the source or the drain to generate photocurrent.

6. The light quantity detection circuit of claim 1, wherein the semiconductor layer of the thin film transistor further comprises a low concentration impurity region disposed between the channel and the source or the drain.

7. The light quantity detection circuit of claim 6, wherein the low concentration impurity region is disposed adjacent part of the channel that receives light.

8. The light quantity detection circuit of claim 1, wherein the first and second resistors are made of a material for a transparent electrode.

9. The light quantity detection circuit of claim 1, wherein each of the first and second resistors comprises a thin film transistor.

10. A light quantity detection circuit comprising:
a photosensor comprising a thin film transistor comprising a gate electrode disposed on a substrate, a semiconductor layer disposed on the substrate, an insulating film disposed between the gate electrode and the semiconductor layer, the photosensor converting light incident thereon into an output comprising an electric signal, and the semiconductor layer comprising a channel, a source disposed at one end of the channel and a drain disposed at another end of the channel;
a first capacitor comprising a first terminal receiving the output of the photosensor and a second terminal applied with a reference voltage;
a first switching transistor allowing a current flow between a first and second terminals thereof, the first terminal of the first switching transistor being connected with the first terminal of the first capacitor;
a second capacitor comprising a first terminal connected with the second terminal of the first switching transistor and a second terminal applied with the reference voltage;
a second switching transistor comprising a first terminal connected with the first terminal of the second capacitor and a second terminal applied with the reference voltage; and
a timing device supplying timing signals to the first and second switching transistors so that electric charges are stored in the first capacitor in response to the output of the photosensor, the electric charges stored in the first capacitor are transferred to the second capacitor by turning on the first switching transistor, and an output voltage is outputted from the first terminal of the second capacitor while the second switching transistor is turned off.

11. The light quantity detection circuit of claim 10, wherein the timing device supplying the timing signals so that the second capacitor is refreshed by turning on the second switching transistor prior to storing the electric charges in the first capacitor.

12. The light quantity detection circuit of claim 10, wherein the gate electrode of the thin film transistor of the photosensor is configured to receive a predetermined voltage to refresh the photosensor after the output voltage is outputted.

13. The light quantity detection circuit of claim 10, wherein the output voltage varies in proportion to the output of the photosensor.

14. The light quantity detection circuit of claim 10, wherein the output voltage is adjusted by changing capacitances of the first and second capacitors.

15. The light quantity detection circuit of claim 10, wherein the thin film transistor is configured to receive light in a junction region of the semiconductor layer between the channel and the source or the drain to generate photocurrent.

16. The light quantity detection circuit of claim 10, wherein the semiconductor layer of the thin film transistor further comprises a low concentration impurity region disposed between the channel and the source or the drain.

17. The light quantity detection circuit of claim 16, wherein the low concentration impurity region is disposed adjacent part of the channel that receives light.

18. A light quantity detection circuit comprising:
a photosensor comprising a thin film transistor comprising a gate electrode disposed on a substrate, a semiconductor layer disposed on the substrate, an insulating film disposed between the gate electrode and the semiconductor layer, the photosensor converting light incident thereon into an output comprising an electric signal, and the semiconductor layer comprising a channel, a source disposed at one end of the channel and a drain disposed at another end of the channel;
a first switching transistor allowing a current flow between a first and second terminals thereof, the first terminal of the first switching transistor receiving the output of the photosensor;
a first capacitor comprising a first terminal connected with the second terminal of the first switching transistor and a second terminal applied with a reference voltage;
a second switching transistor allowing a current flow between a first and second terminals thereof, the first terminal of the second switching transistor being connected with the first terminal of the first capacitor and the second terminal of the second switching transistor being connected with a power terminal;
a third switching transistor allowing a current flow between a first and second terminals thereof, the first terminal of the third switching transistor being connected with the first terminal of the first capacitor;
a second capacitor comprising a first terminal connected with the second terminal of the third switching transistor and a second terminal applied with the reference voltage;
a fourth switching transistor allowing a current flow between a first and second terminals thereof, the first terminal of the fourth switching transistor being connected with the power terminal, the second terminal of the fourth switching transistor being applied with the reference voltage, and a gate of the fourth switching transistor being connected with the first terminal of the second capacitor;
a resistor connecting the power terminal and the first terminal of the fourth switching transistor;
an output terminal connected with a wiring connecting the resistor and the first terminal of the fourth switching transistor; and
a timing device supplying timing signals to the first, second and third switching transistors so that electric charges are supplied from the power terminal to the first capacitor by turning on the second switching transistor, at least part of the electric charges supplied to the first capacitor is discharged through the photosensor by turning on the first switching transistor, and the electric charges remaining in the first capacitor are transferred to the second capacitor by turning on the third switching transistor.

19. The light quantity detection circuit of claim 18, wherein the photosensor comprises additional thin film transistors so as to adjust an output voltage outputted from the output terminal.

20. The light quantity detection circuit of claim 18, wherein the resistor has a resistance between 10³ Ω and 10^{8 Ω.}

21. The light quantity detection circuit of claim 18, wherein the thin film transistor is configured to receive light in a junction region of the semiconductor layer between the channel and the source or the drain to generate photocurrent.

22. The light quantity detection circuit of claim 18, wherein the semiconductor layer of the thin film transistor further comprises a low concentration impurity region disposed between the channel and the source or the drain.

23. The light quantity detection circuit of claim 22, wherein the low concentration impurity region is disposed adjacent part of the channel that receives light.

24. The light quantity detection circuit of claim 18, wherein the resistor is made of a material for a transparent electrode.

25. The light quantity detection circuit according to claim 18, wherein the resistor comprises a thin film transistor.

26. A display panel comprising:
a display unit formed on a substrate,
the display unit comprising;
a plurality of drain lines and a plurality of gate lines that are arranged in a matrix configuration,
a plurality of display pixels, each of the display pixels being connected with one of the drain lines and one of the gate lines; and
a light quantity detection circuit comprising a photosensor converting light incident thereon into an electric signal; and
an external control circuit supplying control signal and a power for driving the display pixels and supplying the control signal, the power or the control signal and power to the light quantity detection circuit for an operation thereof.

27. The display panel of claim 26, further comprising a vertical scanning circuit connected to the gate lines and supplying a scanning signal to the gate lines in response to the signals, wherein the scanning signal is the control signal supplied to the light quantity detection circuit.
